(19) United States
(12) Patent Application Publication
(10) Pub. No.: US 2003/0100420 A1
(43) Pub. Date: May 29, 2003

(54) Bulk box product lamination system

(75) Inventors: Ronald L. Lund, Rockford, IL (US); Tommy I. Haye, West Monroe, LA (US); Dennis W. Wojtow, Cincinnati, OH (US); Karl August Swenson, Fall City, WA (US); Joel Vissia, Lees Summit, MO (US)

Correspondence Address: BANNER & WITCOFF, 1001 G STREET N W, SUITE 1100, WASHINGTON, DC, 20001, US

(73) Assignee: Georgia-Pacific Corporation, Atlanta, GA

(21) Appl. No.: 09/993,942

(22) Filed: Nov. 27, 2001

(51) Int. Cl. B31B 49/00

(52) U.S. Cl. 493/51

(57) ABSTRACT

A bulk box forming system and method in which a compression apparatus receives the liner and a case such that a trailing edge detector signals a compression platen to laminate the liner against the case. A folding apparatus includes a plurality of folding arms and a plurality of case detectors generates detection signals for determining a folded position of the case. A multi-cell insertion and compression station is provided for forming a multi-cell bulk box. A control processor controls the operation of the system by receiving a detection signal of the trailing edge detector and the case detectors.

### FIELD OF THE INVENTION

The present invention generally relates to corrugated paper bulk containers, and in particular to a system and method of manufacturing a laminated bulk box.

### BACKGROUND OF THE INVENTION

In the shipping and packaging industry, laminated bulk boxes are used for transporting dry flowable and liquid bulk materials. In general, laminated bulk boxes are constructed from corrugated fiberboard having several adhesively bonded layers, which increases wall strength to hold the bulk materials. Some laminated bulk boxes are designed to hold up to 2,500 pounds or more of bulk material. One type of bulk box is called a multi-cell bulk box, which generally includes compartments bonded to the interior of the bulk box to retain and transport bulk materials. Multi-cell bulk boxes commonly hold and transport materials such as, thermoplastic resins, uncured rubber, and synthetic rubber. U.S. Pat. No. 5,074,834 to McElhaney et al. discloses an example of a type of multi-cell bulk box.

There have been past attempts of providing a machine for making laminated bulk boxes. Examples of such machines for making laminated bulk boxes are illustrated in U.S. Pat. Nos. 4,949,540 and 3,964,953 to Mitchard. These patents disclose machines for laminating a liner to a body blank. U.S. Pat. No. 4,608,038 to Virta et al. discloses an apparatus and method for lining, folding and gluing prescored container blanks wherein the liner is positioned on a container body blank prior to folding and gluing of the blank. In another example, U.S. Pat. No. 4,368,052 to Bitsky et al. discloses another machine for lining bulk boxes. None of these past machines can produce a multi-cell bulk box.

There has been a long need to accurately control the laminating process to eliminate error. Attempts have been made to use timing sequences to control the automated manufacture of bulk boxes. These control systems perform actions based on when a body blank is presupposed to be at a certain position in the process at a specific time point. U.S. Pat. No. 4,368,052 to Bitsky is one example of a bulk box machine with a timing control system. Both the position and time point must match in these types of control systems, otherwise production error may occur. The control system may improperly and inaccurately laminate a liner to a body blank. For example, a body blank may be positioned partially under a compression plate during a compression operation because of the timing and position requirement of control system. The improper lamination causes weak wall strength and reduced load carrying capacity of the bulk box.

Another drawback of bulk box machines concerns the folding operation. Jamming of the body blank may occur when panels are folded over due to a timing and position problem in the control system. This problem causes production delays and additional production cost. Therefore it is desirable to prevent jamming of the body blank during the folding operation.

The conventional manufacture of a multi-cell bulk box involves numerous man-hours and equipment operating time. The relatively heavy box weights, the number of assembly steps, and the large size of a multi-cell bulk box generally results in a slow, labor-intensive operation. These problems result in reduced ability to meet customer demands for the products. The labor-intensive nature in which the boxes are made results in high manufacturing costs which is not efficient. Further, these conventional production practices increases production error and inconsistent product quality.

### BRIEF SUMMARY OF THE INVENTION

The present invention pertains to an advanced bulk box forming system and a method of forming a bulk box and a multi-cell bulk box without high production error.

In one aspect of the present invention, a liner is placed against a case with adhesive supplied between the two thereby creating a composite blank. The composite blank is then fed to a compression station, which is provided to laminate the liner and case together. As the composite blank is fed, a trailing edge of the composite case is sensed by a sensor. In response to sensing the trailing edge of the composite blank, the compression platen is advanced downward towards the composite blank so that the liner is compressed against the case. The bonded liner and case are folded to bring predetermined panels into an overlapping relationship at a joining portion on one of the predetermined panels. In this way, the active control reduces production errors by fully bonding the case and liner without relying on conventional timing practices.

According to another aspect of the invention, a multi-cell assembly section applies a multi-cell unit against a composite case form by a bonded liner and case. As the composite case is conveyed in a work path underneath a compression platen, a detector generates a detection signal upon sensing the trailing edge of the composite case so as to activate the platen to compress the multi-cell unit against the liner. A control computer includes a program embodied in computer readable code for monitoring and receiving the detection signal from the detector so as to control the movement of the compression platen towards the multi-cell unit. In this manner, a multi-cell bulk box can be efficiently produced with consistent product quality.

According to another aspect of the invention, a folding apparatus includes a plurality of rotatable folding arms and a plurality of case detectors, which generates detection signals that are sent to a control computer so as to verify that the folding arms have folded opposing panels of the case. The control computer includes a computer readable program for execution on a processing unit which receives the detection signals from the case detectors. In this manner, reliable joining of the case panels is ensured in a bulk box or multi-cell bulk box product lamination system.

### BRIEF DESCRIPTION OF THE DRAWINGS

The foregoing summary of the invention as well as the following detailed description of the invention, considered in conjunction with the accompanying drawings, provides a better understanding of the invention, in which like reference numbers refer to like elements, and wherein:

FIG. 1 is a schematic plan view of a system for forming bulk boxes according to an embodiment of the invention;

FIG. 2 is a schematic front elevational view of an initial feeding portion of the system of FIG. 1;

FIG. 3 is a schematic sectional view of the initial feeding portion taken along line 3-3 of FIG. 1;

FIG. 4 is a schematic perspective of view of a rack unit shown in FIG. 2;

FIG. 5 is a schematic top plan of an assembly section according to an embodiment of the invention;

FIG. 6 is a front elevational view of the assembly section shown in FIG. 5;

FIG. 7 is a schematic top plan view of a compression apparatus according to an embodiment of the invention;

FIG. 8 is a schematic rear elevational view of the compression apparatus shown in FIG. 7;

FIG. 9 is a schematic side elevational view of the compression apparatus shown in FIG. 7;

FIG. 10 is a schematic front elevational view of a gluing station according to an embodiment of the invention;

FIG. 11 is an enlarged schematic view of a sensing arrangement of the gluing station shown in FIG. 10;

FIG. 12 is a schematic side elevational view of a multi-cell compression arrangement according an embodiment of the invention;

FIG. 13 is a schematic front elevational view of the of a multi-cell compression arrangement shown in FIG. 12;

FIG. 14 is a schematic top plan view of a folding unit according to an embodiment to the invention;

FIG. 15 is a schematic rear elevational view of the folding unit shown in the FIG. 14;

FIG. 16A is a partial sectional view of the folding unit taken along line 16A-16A in FIG. 14;

FIG. 16B is a sectional view of the folding unit in taken along line 16B-16B in FIG. 14;

FIG. 17 is a schematic diagram of an embodiment of a controller unit of the system of FIG. 1;

FIG. 18 is a flow diagram of an embodiment of manufacturing a bulk box and multi-cell bulk box product; and

FIG. 19 is a schematic perspective exploded assembly view of a multi-cell bulk box.

### DETAILED DESCRIPTION OF THE PREFERRED EMBODIMENTS

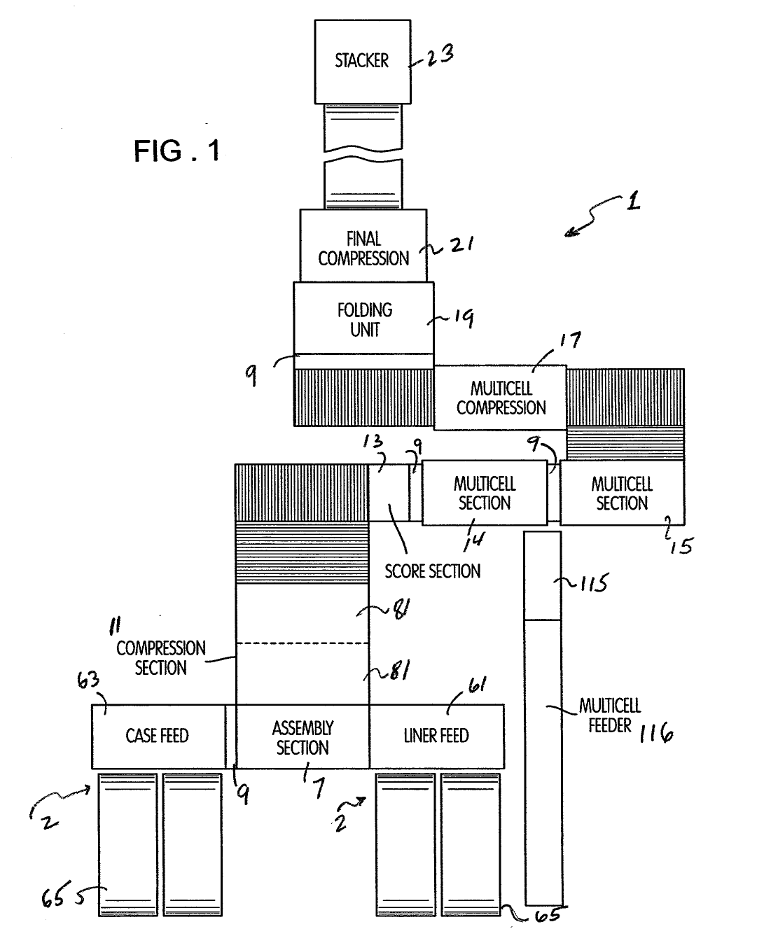

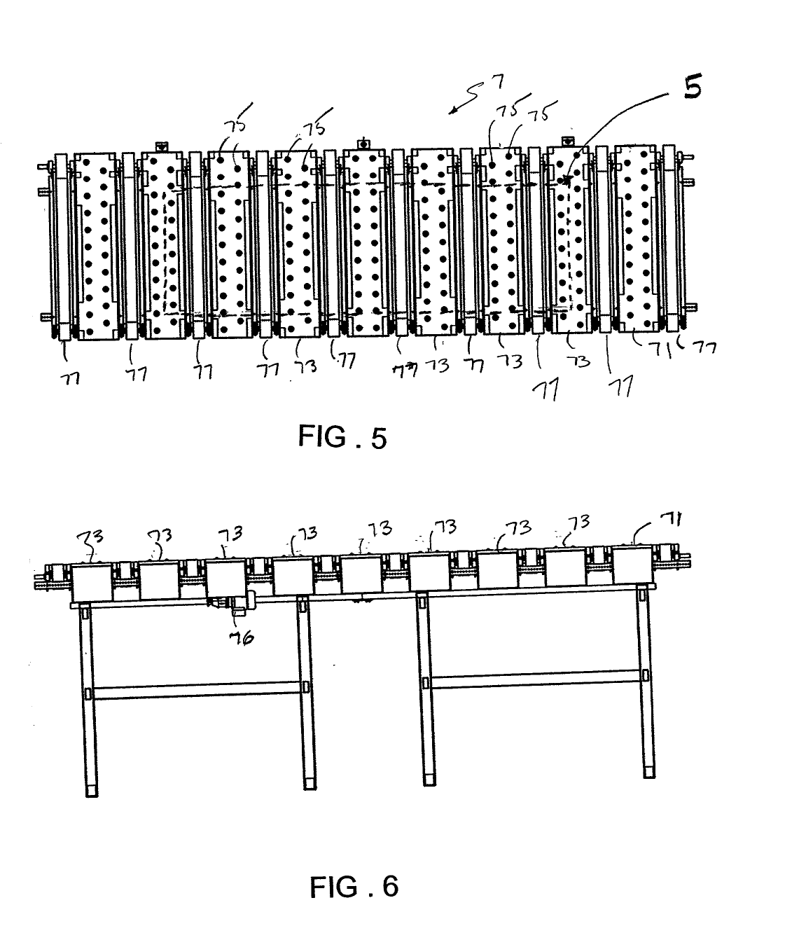

FIGS. 1-18 illustrate an embodiment of an integrated system and method for producing a corrugated bulk box or a multi-cell bulk box according to the teachings of the present invention. Referring to FIG. 1, as an overview of the preferred embodiment, forming system 1 includes a feeding apparatus 2 for transporting a liner or liner board 3 and a case or case board 5 to an assembly section or make-up station 7. At the assembly section 7, liner board 3 is positioned on top of the case board 5. Adhesive material is applied to the case board (or the liner board) to affix the two boards together. The bonded boards are then conveyed to a compression section 11 so that a compressive force is applied to the liner and case to define a composite blank. A scoring section 13 applies a plurality of score lines on the liner board and case board at predetermined positions so that a bulk box can later be folded to form a single box unit.

In a preferred construction, forming system 1 is configured to produce a multi-cell bulk box in which one or more multi-cell units are positioned and affixed to the laminated case board and liner board at multi-cell insertion stations 14, 15. A multi-cell compression apparatus 17 simultaneously laminates the multi-cell units to each other and a cell unit against the liner. In an alternative construction, multi-cell insertion stations 14, 15 and compression apparatus 17 could be removed to form bulk boxes. In this construction, the composite blank is transported from the scoring station to a folding unit 19 by a different conveyor (not shown). Alternatively, the composite blank could simply pass through the multi-cell insertion stations and compression apparatus 17, if a change in construction is not desired.

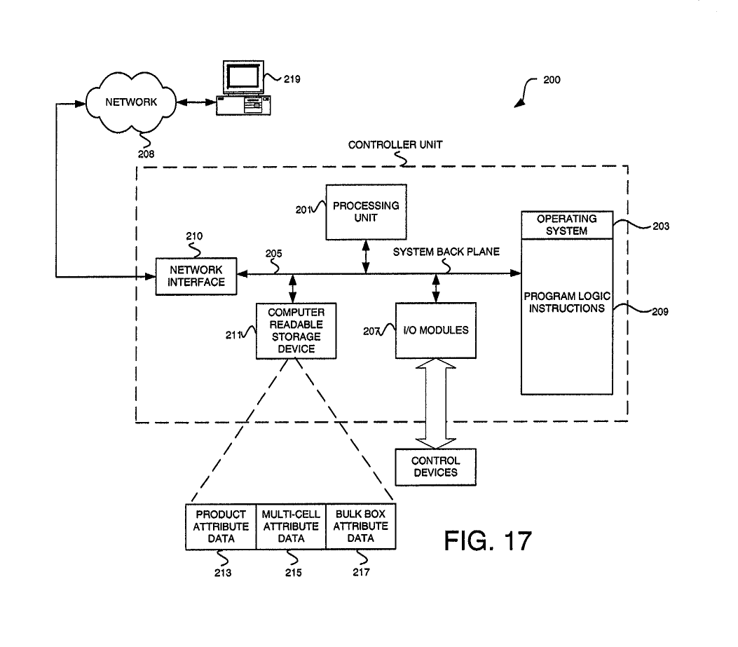

Folding unit 19 folds opposing panels of the laminated composite blank into a flat tubular box connected by a glue tab on one of the panels and preferably folds the panels on to a multi-cell unit. System 1 also includes a compression section 21 that enables the box to be securely bonded on the glue tab. Compression section 21 preferably compresses the glue tab and the opposed panels to the multi-cell unit to form a bond. A stacker unit 23 stacks the flat boxes for transportation and storage. System 1 preferably operates in a semi-automated manner controlled by a microprocessor controller unit 200 operatively connected to several control circuits and control devices (FIG. 17). Each production component is capable of holding a case, in queue, if there is a slow up downstream. In one embodiment, controller unit 200 has selective mode control to enable manufacturing of a bulk box or a multi-cell bulk box to be produced with forming system 1.

The inventive forming system 1 and the improved method for producing a bulk box have several features that produce synergistic effects, such as improved product yield by reducing waste, reduced manufacturing costs by reducing labor overhead by approximately 50%, and improved time to the market of a bulk box by speeding manufacturing time. The inventive operation of system 1 significantly reduces errors and thus produces a consistent product without significant variations in product quality. In a preferred construction, the forming system produces approximately 120-160 multi-cell bulk boxes per hour, which is a significant improvement over conventional practices.

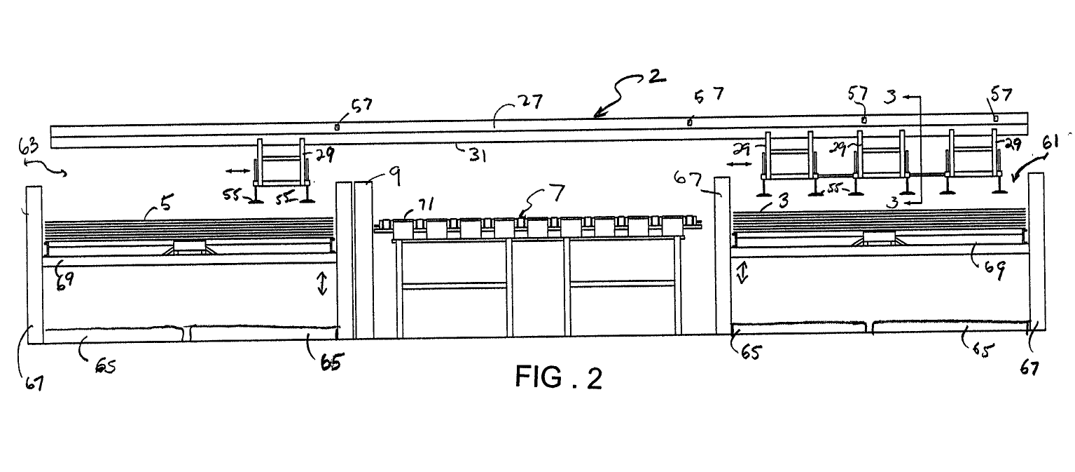

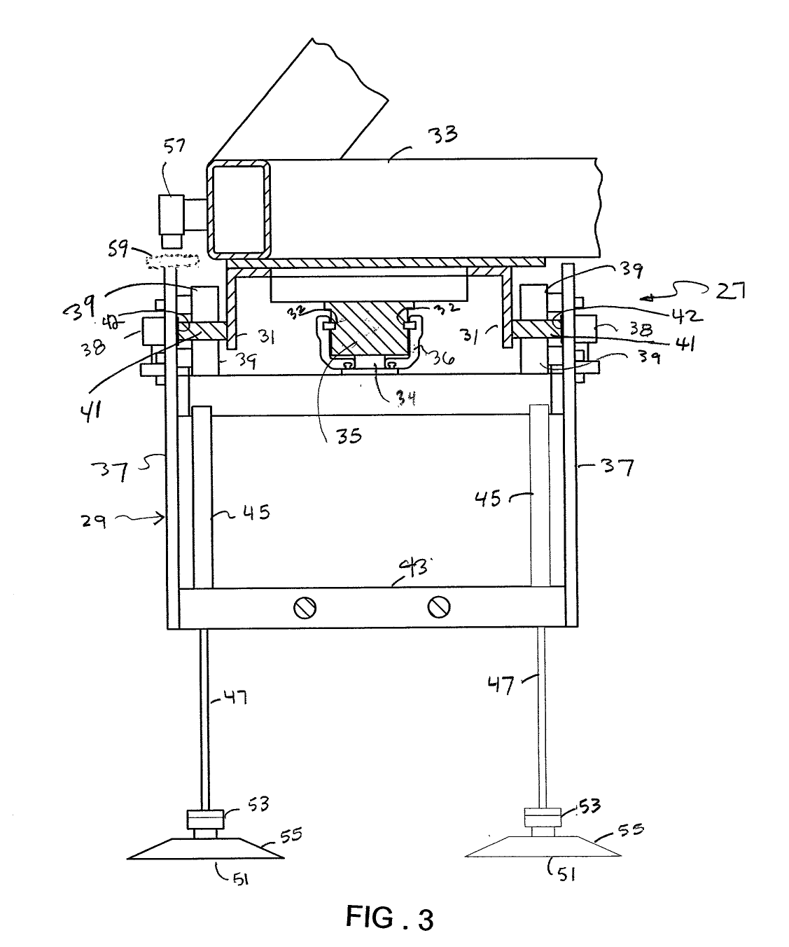

To provide a better understanding of the inventive forming system, a preferred embodiment is described in more detail below. Referring to FIGS. 2 and 3, a feeding apparatus 2 is provided to each side of the assembly section 7 for feeding cases 5 and liners 3 for assembly together. Feeding apparatus 2 preferably comprises a shuttle or doffing apparatus 27 for lifting and transporting the cases and liners to assembly section 7, however, other feeding devices could be used. For ease of explanation, the terms “liner feed side” refers to the side of assembly section from where liners 3 are initially setup for production. Likewise, the terms “case feed side” refers to where the cases 5 are initially setup. It should be recognize that the locations can be reversed if another construction of the feed sides is desired.

Shuttle apparatus 27 preferably comprises a plurality of rolling rack units 29 hung downwardly from a plurality of traverse beams 31. Traverse beams 31 extend from the liner feed side across assembly section 7 to the case feed side. Each traverse beam 31 has an upper surface fastened to the underside of a cantilevered support structure 33. A set of rack units 29 are provided on the case feed side and liner feed side for transporting the respective product to the assembly section. The number of rack units 29 on each side depends on the size and weight of the board. Rack units 29 on the case and liner feed sides are configured to independently move relative to each other.

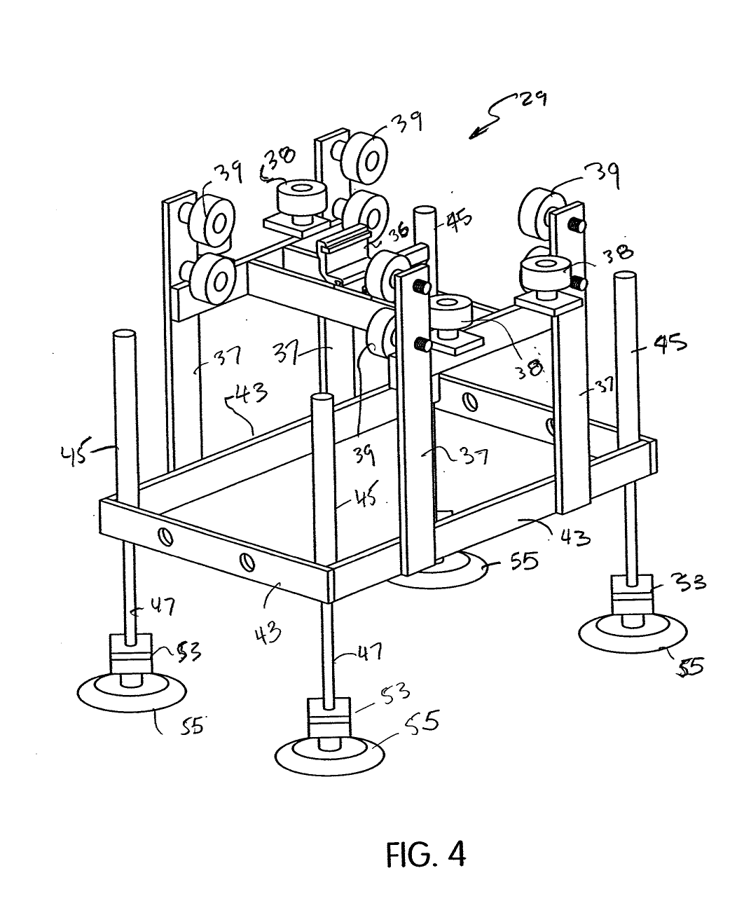

In a preferred construction, the rack units are mounted to a linear actuator system 35 for movement along beams 31 (see FIG. 3). The linear actuator system 35 is mounted between the traverse beams. In one embodiment, the linear actuator system 35 includes independently controlled rodless cylinders coupled to the rack units for the case feed and liner feed sides. The rodless cylinders may have a drive system that can take on several conventional forms, such as a screw drive, a belt drive, or air puck system. Referring to FIGS. 3 and 4, each rack unit 29 includes a winged mating device 36 that reliably couples with a rectilinear moveable carriage 34 of the rodless cylinder. The rodless cylinder 35 has two grooves 32 for guiding mating device 36 during movement of the carriage.

Each rack unit 29 further includes vertical support members 37 each having a set of opposed rollers 38, 39 that engage a ledge 41 of the traverse beams 31. As best seen in FIG. 3, rollers 38 are preferably mounted to the side edge 42 of the ledge 41 to prevent rotational movement or swaying around the center axis of the rodless cylinder 35. This arrangement ensures accurate alignment of the boards to keep the boards substantially square or perpendicular to the work path, preferably, as the case is fed into the gluing station 9 on the case feed side (FIG. 2).

As shown in FIGS. 3 and 4, the lower end of support members 37 are preferably welded to a rectangular frame comprising welded flat bars 43. Each rack unit 29 includes several pneumatic linear actuators 45 mounted to the flat bars 43 of the frame; although other types of activators could be used. Each linear actuator 45 includes a rectilinear movable rod 47 having a vacuum cup apparatus at the distal engaging end 51. Vacuum cup apparatus 49 comprises a valve unit 53 and a flexible vacuum cup 55. The vacuum pressure is applied through the vacuum tubes (not shown) connected to valve unit 53 to reliably grip and hold the case and liners. The use of independent actuators 47 for each vacuum cup 55 provides for an improved engagement of warped cases or liners.

With reference to FIGS. 2 and 3, automatic transverse movement of rack units 26 is accomplished by linear actuator system 35 preferably coordinated by controller 200 via a plurality of rack position sensors 57. Rack position sensors 57 are mounted above one of the traverse beams 31 so that underlying rack units 29 can be detected. Rack position sensors 57 are preferably mounted at predetermined locations on an outer portion of the traverse beam. These predetermined locations are chosen depending on the type of bulk box product that is to be made by the system.

Nevertheless, there are a number of arrangements that can be used to sense the rack unit position. In one arrangement, each position sensor 57 is a photoelectric sensor that detects an object. The sensors can be disposed so that a beam of light is directed downwardly to detect when a rack unit 29 pass under the light. In an alternative arrangement, the position sensors may be bi-state type that changes states when an object is detected. For example, one type of bi-state sensor that could be used generates a detection signal when a magnetic field is created between a metal plate 59 mounted along the top of the rack unit shown in FIG. 3. Other types of sensing devices may also be used, such as contact sensors, capacitive sensors, or limit switches. Rack position sensors 57 are operatively coupled to microprocessor controller unit 200 by interface control hardware, such as wires or wireless connections (not shown). This configuration enables controller unit 200 to receive and process detection signals generated by rack position sensors 57.

As shown in FIGS. 1 and 2, feeding apparatus 2 further comprises a liner feed 61 and a case feed 63 for assembly section 7, respectively. In a preferred construction, liner feed 61 comprises a floor level belt conveyor 65 (or other axial drive means) connected to a lifting apparatus 67. Likewise, case feed 63 includes a similar conveyor and lifting apparatus. Because each lifting apparatus 67 is a similar construction, the details of one lifting apparatus will be illustrated for ease of explanation. A forklift machine (not shown) or other heavy lifting means places stacks of cases and liner on the belt conveyor 65. Referring to FIG. 2, stacks of liners or cases are placed on belt conveyor 65 and a platform surface 69 of the lifting apparatus 67 is lowered to received the stacks from the conveyor 65. Alternatively, the belt conveyor 65 can be removed and case or liners can be placed directly on the platform surface 69 by the forklift machine. Lifting apparatus 67 includes a lift mechanism such as, a four post lift, mounted to the underside of the platform surface 69 to move the cases or liners to a predetermined level for pickup by the vacuum cups 55 of the rack units 29. The predetermined level may be the height of assembly section 7 or another working height suited for the rack units. Of course, other types of lifting apparatus could be used, such as a scissor lift. Also, alternatively, surface 69 could be at a fixed height and rack unit 29 provided with a greater range of vertical displacement with actuators 45 or by another means.

A stack height sensor (not shown) cooperates with microprocessor controller unit 200 so that the case or liner stacks are raised upwardly to the table height or the working height by the lifting apparatus 67 as a single case or liner is removed from the respective stacks by the rack unit 29. The stack level sensor may be a photoelectric sensor that detects an object or absence of the object. Alternatively, the stack level sensor may be a bi-state type that changes states when an object is detected, such as a case or liner. Nevertheless, other types of sensing devices may be used, such as capacitive sensors.

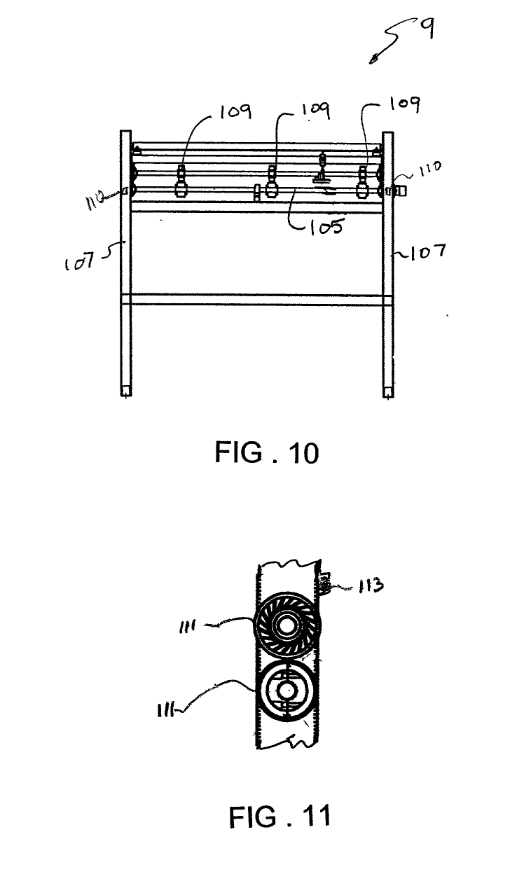

Referring to FIG. 1, the gluing stations 9 of forming system 1 are substantially identical except for some adaptations. As a result, the details of one station will be described. As shown in FIG. 10, glue station 9 includes a frame having a rod 105 spanning between vertical members 107. A plurality of computer controlled contact extruded glue application heads 109 are mounted to rod 105. The number of glue heads for glue station ranges from 12 to 16. The specific number of heads can be adjusted, accordingly. The glue heads can be obtained from VALCO Cincinnati of Ohio, USA. In the preferred construction, rod 105 travels downwardly towards a case or liner or away therefrom under the control of controller unit 200. Advantageously, the movement of rod 105 is accomplished by way of inflatable air bag actuators 110 (shown as dotted lines in FIG. 10) mounted to the opposing ends of rod 105. In use, when the air bags are inflated, the rod 105 moves upward. When the air bags are deflated, the rod moves downward towards a case or liner. The air bags actuators are less expensive than conventional pneumatic or hydraulic cylinders. In addition, air bag actuators 110 have a significantly lower maintenance profile which reduces the overall operating cost of forming system 1. Of course, glue station 9 can have additional rods with attached glue heads.

Referring to FIG. 11, gluing station 9 further includes a set of pinch rollers 111 which are mounted to the inside portion of vertical members 107. Pinch rollers 111 securely grips the leading edge of a case and advances the case underneath the glue heads. A sensor 113 detects the leading edge to start application of adhesive to the case, liner, or multi-cell unit depending on the type of box being formed on the system. The length of the case may be predetermined and an encoder (not shown) determines the length from the detection of the leading edge to apply the desired amount of adhesive.

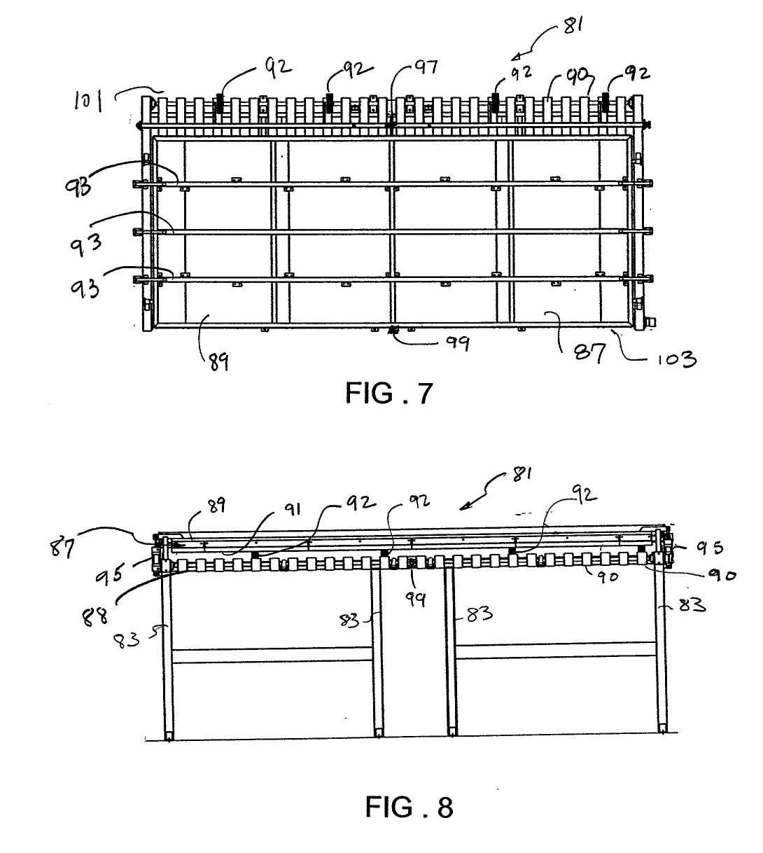

Referring to FIGS. 2, 5 and 6, assembly section 7 includes a horizontal planar work surface 71 for receiving the case board 5 (shown in phantom lines in FIG. 5) after adhesive is applied by gluing station 9. Alternatively, the adhesive may be applied to the liner. Work surface 71 preferably comprises discrete regions 73 separated by endless belts 77. Each of the regions 73 include a plurality of spaced ball bearings 75 to enable a case board to roll across the top of the ball bearings. The endless belts 77 interposed between the regions extend transversely across work surface 71 to move the coupled case and liner to the downstream compression section 11 (FIG. 1). In use, the belts 77 are initially positioned below the plane of the ball bearings. Upon command of the control processor 200, belts 77 move upward and contact or otherwise engage the undersurface of a case to convey it to compression section 11 shown in FIGS. 1 and 7. Motor 76 is configured to rotate endless belts 77 upon actuation by controller unit 200 or other method. Work surface 71 further includes locating pins (not shown) for registration of the case and liner for alignment of the case into compression section 11. The locator pins contact the trailing edge and opposing side edges of the case.

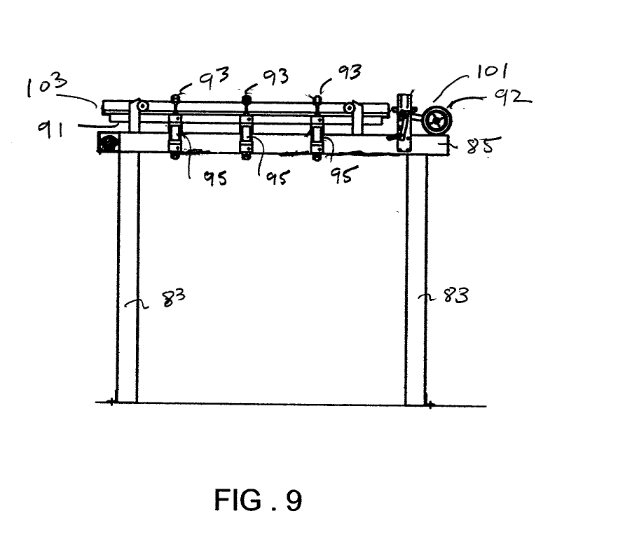

Referring FIGS. 1 and 7-9, forming system 1 next includes compression section 11 serving to laminate a liner to a case. Compression section 11 preferably includes two serially disposed compression apparatus 81. The two compression apparatus 81 cooperate to provide a generally constant unit production speed configured with the adhesive bonding time. The apparatus 81 adjacent to assembly section 7 provides compression for a tacky bonding between a case and liner. The subsequent apparatus 81 provides compression for curing the tacky bonding. If desired, additional compression apparatus may be placed in series. In an alternative construction, one compression apparatus 81 can be used. For ease of explanation, the details of only one of the compression apparatus will be described. As best seen in FIGS. 8 and 9, compression apparatus 81 is preferably constructed from vertical support members 83, opposing horizontal support members 85, a compression platen 87, and a transport surface 88. Vertical support members 83 serve to support the components above a floor surface.

Compression platen 87 includes multiple layers—a top layer 89 and a board contact layer 91. Top layer 89 is composed of a rigid planar board, such as wood or metal for ample support in compression. Board contact layer 91 comprises of a resilient material, such as a foam pad, for contacting the liner to prevent damage during the compression operation. The top layer of compression platen 87 preferably includes a plurality of spaced horizontal spanning support beams 93 that provide greater rigidity to the planar board. Pneumatic actuators 95 are mounted along opposite sides to vertically move compression platen 87 toward and away from the case and liner for a compression operation. Specifically, the actuators 95 are preferably pivotally attached between the lateral ends of support beams 93 and support members 85. In a preferred construction, the actuators provide approximately 2.0 to 4.0 pounds per square inch (psi) of pressure, and most preferably 3.5 psi to the case and liner. The pressure values can be varied depending on the duration of the applied pressure and the type of adhesive being implemented. In a preferred embodiment, the duration of a compressive force is generally ten seconds. Of course, the duration of the compressive force can be adjusted to other values.

Transport surface 88 includes a plurality of spaced endless belts 90 so that a case with a liner is conveyed into and out of compression apparatus. Compression apparatus 81 includes an inlet end 101 that receives a case with a liner and an outlet end 103 that discharges the laminated liner and case. Wheels 92, located at inlet end 101, function to apply downward pressure to ensure that the bonded case and liner are kept against belts 90.

With continued reference to FIGS. 7-9, compression apparatus 81 further includes inlet and outlet case sensors 97, 99 for enabling controlled advancement of the case and liner underneath compression platen 87. In particular, case sensors 97, 99 sense the leading and trailing edges of the case board. In one arrangement, sensors 97,99 are optical that direct a beam of light downward or upward to detect when a case edge passes through the light. In operation, inlet sensor 99 can be configured to sense the case leading edge and also preferably the trailing edge as a case is conveyed from assembly section 7 to a position underneath compression platen 87. The detection of the case leading edge indicates or otherwise signals controller unit 200 that the case has arrived in the compression apparatus 81. After a liner is compressed against the case, outlet case sensor 99 detects the trailing edge of the case and signals the controller unit that the compression section is ready to receive additional cases.

Advantageously, the detection of the case trailing edge signals the controller unit 200 that the case has been advanced into a position securely underneath compression platen 87 for a compression operation. Responsive to the trailing edge detection, compression platen 87 is actuated and advanced towards the case and liner by actuators 95 under automatic control of controller unit 200. In one embodiment of the invention, case sensors 97, 99 may be a photoelectric sensor that detects an object. Nevertheless, other types of sensing devices may be used, such as contact sensors, capacitive sensors, or limit switches. A capacitive sensor can sense the trailing edge of the case board by sensing a change in capacitance from the case when the trailing edge advances by the detector. Case position sensors 97, 99 are operatively coupled to microprocessor controller unit 200 by interface control hardware, such as wires or wireless connections. This likewise enables controller unit 200 to receive and process a detection signal generated by case sensors 99, 97.

There are other approaches contemplated for signaling compression platen 87 to advance downward towards the liner or the case. In one alternative approach, upon detection of the case leading edge, an encoder may be started to determine when the affixed case and liner are positioned beneath the compression platen. In the encoder embodiment, a predetermined number of counts can be logically mapped to the length of the case. While the case is advanced in the compression section, the encoder can be configured to provide counts that are received by controller unit 200. Upon determining the specified number of pulses, the compression platen 87 can be actuated downwardly. The number of pulses depends on the type of encoder. Possible encoder alternatives may include a rotary type or a linear encoder configured to continually sense the leading edge of the case board while advancing under the compression platen.

In these ways, the active control reduces production errors by enabling compression apparatus 81 to fully compress the case and liner (or a multi-cell unit) without relying on conventional timing patterns to bring a compression surface towards a case and liner. The sequential detection of the leading edge and trailing edge enables different length cases to be used without adjustment for timing. In addition, a case will be appropriately sensed to start the compression operation as soon as the case is positioned under the compression platen 87. This is advantageous to cooperate with the adhesive set-up time for tackiness and curing.

Scoring station 13 (FIG. 1) is constructed from a three bar conventional automatic scoring machine. The bars (not shown) of the scoring station deformed the liner and case to form score lines at predetermined positions so that a bulk box can later be folded to form a single unit. In use, as the case and liner are transported underneath the bars, the bars move downward and crushes the corrugated case and liner. One of ordinary skill in the art will recognize additional bars could be added to the scoring station.

Purely by way of example without limitation of the present invention, a type of multi-cell bulk box is shown in FIG. 19, which has a case 5 and two liners 3 sized to fit against two opposing panels of the case. Multi-cell units 4 are bonded against each other and each is bonded to the liners, respectively. To provide a multi-cell bulk box, referring to FIG. 1, multi-cell insertion stations 14, 15 are production stations in the work path whereby a multi-cell unit is aligned and placed on the liner automatically or manually. An upstream insertion station 14 is provided so that a first cell unit can be placed on the laminated case and liner. A downstream insertion station 15 is provided for a second cell unit to be place on top of the first cell unit, if needed. Glue station 9 is interposed between the stations 14,15 so that adhesive can be applied to the exposed surface on the first cell unit for coupling the second cell unit.

To provide the cells to the operators or other placement means, a cell lift 115 is provided in proximity to stations 14, 15. Cell lift 115 may be a scissor lift mechanism or similar system, such as post lift 67 (shown in FIG. 2). The multi-cell units are conveyed to the insertion stations by way of a feeder system 116. Feeder system 116 may include an endless belt conveyor or other similar conveyance machine. In one embodiment for automatic placement of the cell unit, a vacuum cup apparatus (not shown) may be placed over the liner, in which a multi-cell unit is lifted from the cell lift and lowered on the liner. Yet in another alternative embodiment, a robotic control arm (not shown) configured to sense the case and liner places a multi-cell unit in the proper position. It is also contemplated that other alternatives are possible for insertion of the multi-cells to the laminated liner and case.

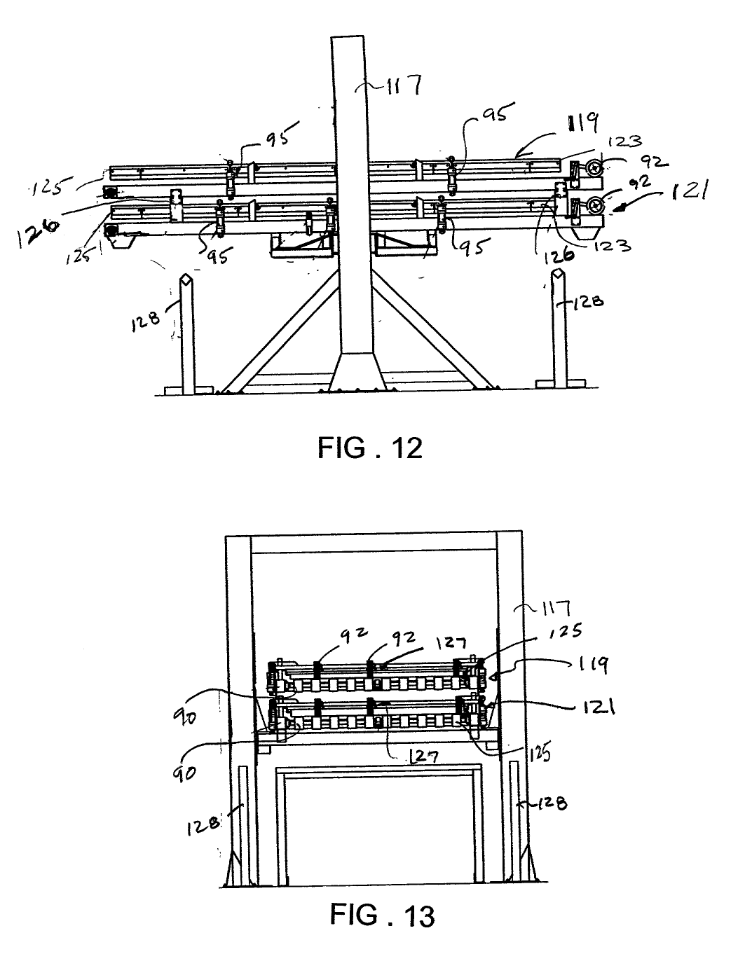

Referring to FIGS. 12-13, multi-cell compression apparatus 17 includes a hydraulic lift 117 that retains a top compression assembly 119 and a bottom compression assembly 121. Each assembly 119, 121 includes a compression platen 123 and an endless belt conveyor 125. The compression assemblies 119, 121 move vertically along lift 117 to align with the working height of the work path so as to receive the multi-cell unit, as well as the laminated case. The stacked arrangement provides for increased throughput of the multi-cell product resulting from system 1.

Top and bottom compression assemblies 119, 121 are interconnected by vertical connectors so that the assemblies move up and down along lift 117 as an integral unit. The connectors are preferably metal plates fastened to the assemblies on the horizontal support members. Vertical stops 128 form a lowest level to stop the downward movement of the compression assemblies for safety. Compression assemblies 119, 121 have a similar construction to compression apparatus 81. Similarly, as with compression apparatus 81, an inlet sensor 127 is independently provided on each compression assembly 119, 121 so as to generate a detection signal upon sensing the trailing edge of the case board with multi-cell units. Preferably, the case and liner are conveyed to a position beneath the compression platen so that the multi-cell unit is compressed against the liner bonded to the case. Alternatively, if additional multi-cells are inserted in the downstream insertion station 15 shown in FIG. 1, two multi-cell units are compressed against each other. In this way, the multi-cell units can be efficiently laminated to each other and to the liner.

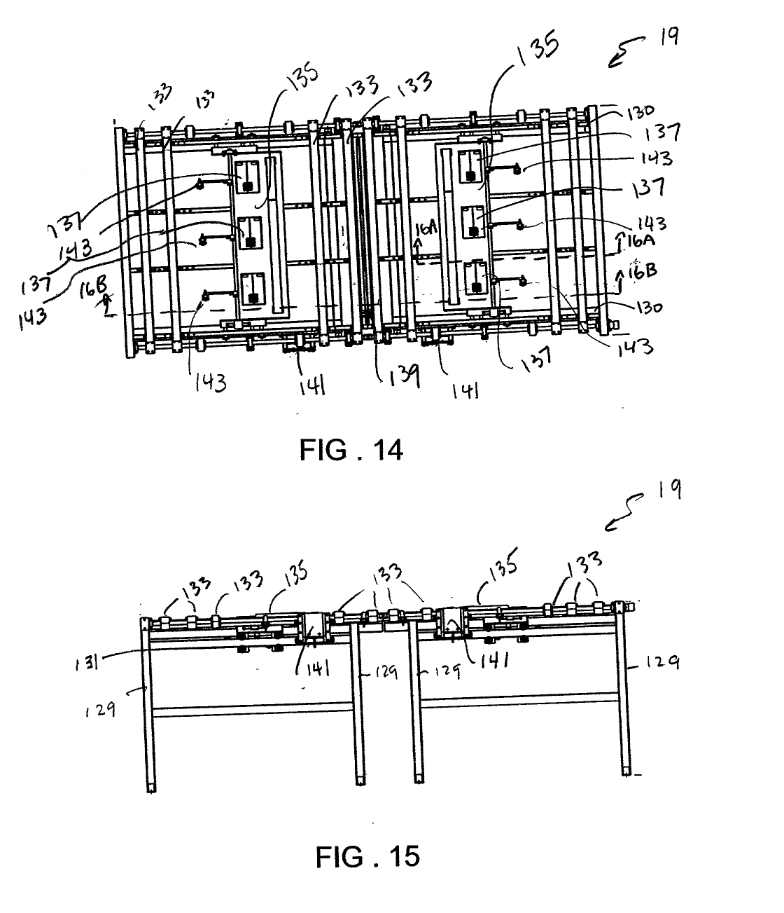

Referring to FIGS. 14-16A and 16B, folding unit 19 is provided to fold the laminated case into opposing panels to form either a bulk box or a multi-cell bulk box. Whether a bulk box or multi-cell box unit is folded depends on the mode of operation for system 1. Folding unit 19 comprises vertical supports 129 serving to support the unit above a floor or ground surface. A rectangular frame 131 is mounted to the vertical supports. A plurality of spaced endless belts 133 preferably advances the laminate board including the case board, the liner and multi-cell unit (called a case product) into and out of the folding unit.

A plurality of laterally spaced work platforms 135 are positioned in the middle portion of the rectangular frame so that the case product is positioned and stopped for a folding operation. As best seen in FIG. 14, work platforms 135 include selective independent negative pressure regions 137 configured to hold down the bottom surface of the case product during a folding operation. The regions are located at regular spaced predetermined locations on each folding surface 135. The spacing and selective control provides for flattening and securely holding warped cases, in each region against the folding surface. Folding unit 19 also includes a load position sensor 139, such as a photoeye, that signals when a case product has been positioned for a folding operation. When the position signal is received negative pressure regions are activated.

As best seen in FIG. 15, the folding unit 19 includes linearly actuated backstops 141 disposed at the discharge end of the work platforms. The backstops 141 are preferably metal plates mounted to pneumatic cylinders (not shown). The backstops 141 move upward into the path of the case prior to the case entering the folding unit. In operation, while the case product is advanced in the folding unit, the leading egde (or leading end) of the case product is overdriven into the backstops by belts 133 thereby tending to keep the case leading edge generally perpendicular to the work path direction. Once the leading edge contacts the backstops, a contact switch (not shown) stops the belts 133 via controller unit 200. Advantageously, this arrangement prevents jamming of the case product. After the case product is folded, the backstops move downward out of the work path.

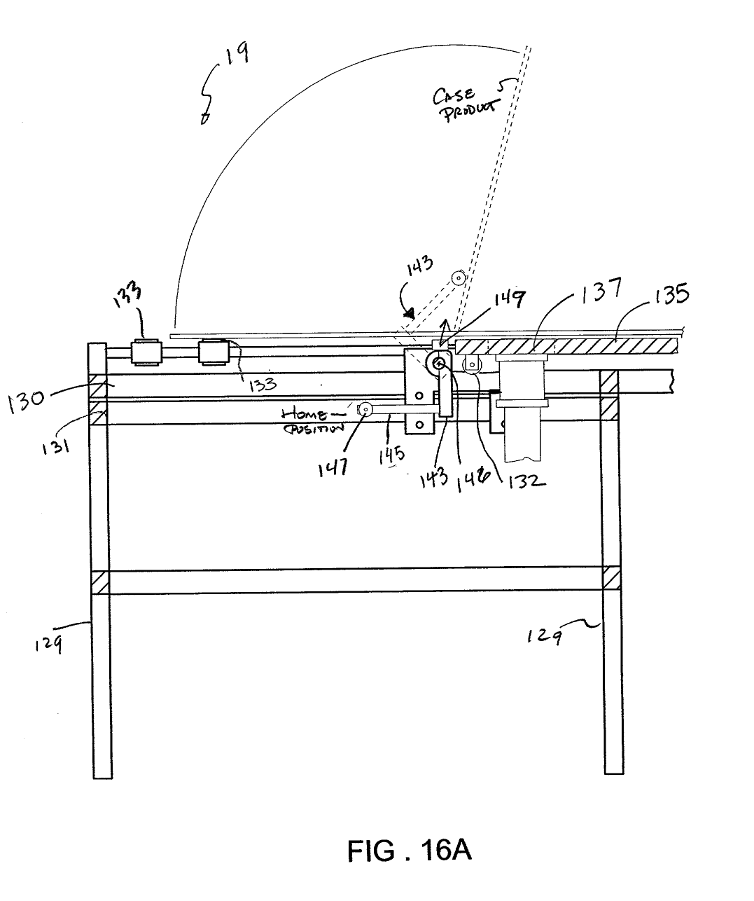

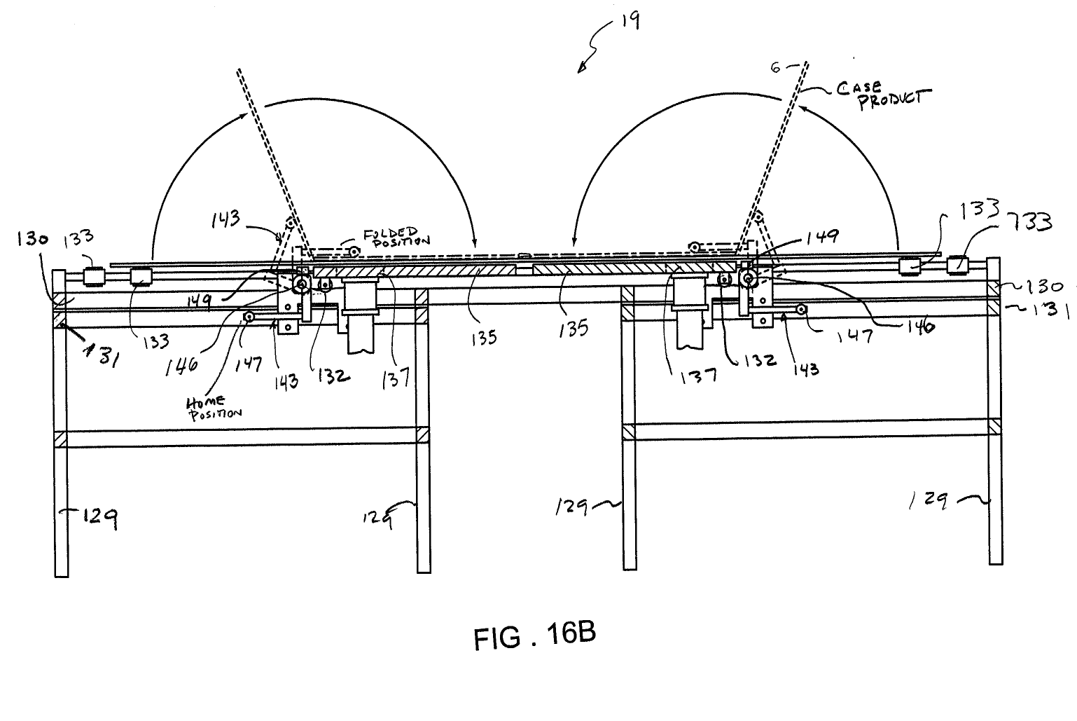

As best shown in FIGS. 16A and 16B, rotary folding arms 143 fold over opposing panels of the case product in which the panels are placed into an overlapping relationship at a glue tab 6 (FIG. 16B) disposed one of the other panel. Sets of folding arms 143 are disposed on the outermost sides of work platforms 135. Each folding arm 143 includes an elongated metal bar 145 having the proximal end mounted to a rotatable rod 146 that rotates under hydraulic power. When the metal bar is rotating upward, as shown in broken lines, the distal ends of the metal bar have a pad 147 that engages the case product being held on work platforms 135. The left and right folding arms 143 are selectively controlled by controller unit 200 and operate independent of each other. This enables varying the sequence of rotating the left and the right folding arms. Each work platform 135 is located at desired positions transverse to the work path so that different box sizes can be constructed and folded. To accomplish the movement, the work platforms roll on rails 130 by way of wheels 132. The operator can adjust the positions prior to a production run. It should be appreciated that, the folding arms are connected to work platforms 135, such that the arms also move transverse to the work path along with the movement of the work platforms.

With reference to FIGS. 16A and 16B, to perform a folding operation, the arms have at least two positions—a home and a folded position. The home position is defined when arms are initially positioned. The folded position is defined when the arms have fully rotated approximately 180 degrees or more so as to fold a panel of the case product. Advantageously, folding unit 19 includes a plurality of case sensors 149 that generate detection signals so as to verify that the folding arms have folded opposing panels of the case product. Sensors 149 are located to the side edge of the work platforms. In the preferred construction, sensors 149 are photoelectric sensors that “look upward” towards the case product. Nevertheless, other types of sensing devices may be used, such as contact sensors, capacitive sensors, or limit switches, or sensors that detect the position of folding arms 143.

Case sensors 149 detect the presence or absence of opposing panels to be folded over to attach to the glue tab 6. After the arms have reached the folded position and a “presence” signal is detected, the folding unit is temporarily stopped and controller unit 200 alerts an operator. However, in response to an “absence” signal the folded case product is advanced into the compression station 21 shown in FIG. 1. Folding arms 143 and at least one corresponding position is schematically shown in broken lines for the absence signal. In this manner, the possibility of jamming the production operation is prevented and reliable joining of a case product at the glue tab to form an overlapping joint between the panels is assured.

Compression section 21 (FIG. 1) may have a similar construction as compression apparatus 81. In the preferred construction, compression section 21 may have a stacked configuration similar to the multi-cell compression section 17. Compression section 21 can have up to four compression assemblies. In an alternative construction of forming system (not shown), the stacked configuration may be used in compression section 11. The size of the bulk box cases and the stacking of the compression assembly would be adjusted, accordingly. One of ordinary skill in the art would recognize modification to the operation and programming in control unit 200 would be made.

Referring to FIG. 17, microprocessor controller unit 200 preferably comprises a computing device for controlling system 1. In one embodiment of the invention, controller unit 200 comprises a central programmable logic control unit (PLC) or a series of independent central programmable logic control units configured for providing semiautomatic or automatic processing operation. Likewise, controller unit 200 may be a general purpose computer configured to operate with such programmable controllers. Nevertheless, those having ordinary skill in the art can readily program the operational logic sequences for forming system 1.

As shown schematically in FIG. 17, in one embodiment of the invention, controller unit 200 comprises a SLC 500 series programmable controller including 1746 series digital and analog input/output modules commercially available through the Allen-Bradley Company of Milwaukee, Wis., a division of Rockwell International; however, other suitable equipment or devices may be used for the controller unit. Hardware components of microprocessor controller unit 200 may include a processing unit 201, a system memory 203, and a system backplane 205 that forms a data pathway for input/output modules 207. Input/output modules 207 interface with various control devices, such as the sensing devices and control valves comprising system 1. Processing unit 201 may be a suitable microprocessor used in industrial control systems. System backplane 205 may be any of several types of conventional backplane structures. System memory 203 includes computer readable code in the form of read only memory (ROM) and random access memory (RAM). System memory 203 stores programmable instructions of the operational logic sequences 209 that are executed by processing unit 201.

Controller unit 200 may further include a computer readable storage device 211 that may comprise an Eraseable Programmable Read Only Memory (EPROM), Electrically Eraseable Programmable Read Only Memory (EEPROM), or battery backed-up RAM. Storage device 211 and associated computer-readable media provide nonvolatile storage of computer readable code and operational logic sequences 209. In a further arrangement, controller unit 200 may operate in a networked environment 208 using a network interface 210. The networked environment may include a local area network (LAN) any number of networking signaling used in conventional industrial control systems, such as Ethernet, Controlnet, Devicenet, or Datahighway plus.

Advantageously, forming system 1 may be configured with an operative connection to an internet protocol (IP) network which enables access for devices on the World Wide Web to provide provisioning and other features. In one arrangement, production data, such as the number of units produced, and type of box units may be viewed from a remote location using a computer terminal running a conventional web browser. In this manner, a production manager is enabled to receive production information via an internet connection and perform electronic commerce transactions.

With continued reference to FIG. 17, according to an embodiment of the invention, storage device 211 includes a plurality of product attribute data 213 linked for selective mode control of forming system 1. Product attribute data 213 may include multi-cell bulk box attribute data (MCAD) 215, which indicates that a multi-cell bulk box will be manufactured on forming system 1. Product attribute record 213 may further include a bulk box attribute data (BBDA) 217 indicating a bulk box will be manufactured on system 1. The bulk box attribute data and multi-cell bulk box attribute data provides mode control to cause microprocessor controller unit 200 to execute commands of engaging and disengaging components of forming system 1.

By way of example, multi-cell bulk box attribute data 215 enables controller unit 200 to engage multi-cell inserting stations 15 and multi-cell compression apparatus 17 and associated gluing stations for forming a multi-cell bulk box. While, bulk box attribute data 217 enables controller unit 200 to disengage multi-cell inserting stations 15 and multi-cell compression apparatus 17 for compression operations. Nevertheless, the multi-cell and bulk box attribute data enables controller unit 200 to perform other commands relating to glue head application lengths, compression time durations of the compression apparatus and the multi-cell compression apparatus, and other machine parameters. In this manner, a multi-cell bulk box and a bulk box can be efficiently formed on an integrated manufacturing platform.

It should be apparent that pneumatic operated components described are interconnected to a pneumatic system in which the intended function of the component is controlled by microprocessor controller unit 200 via an air control valve (not shown). The control valve includes a solenoid that opens and closes according to an electrical signal transmitted by the controller unit.

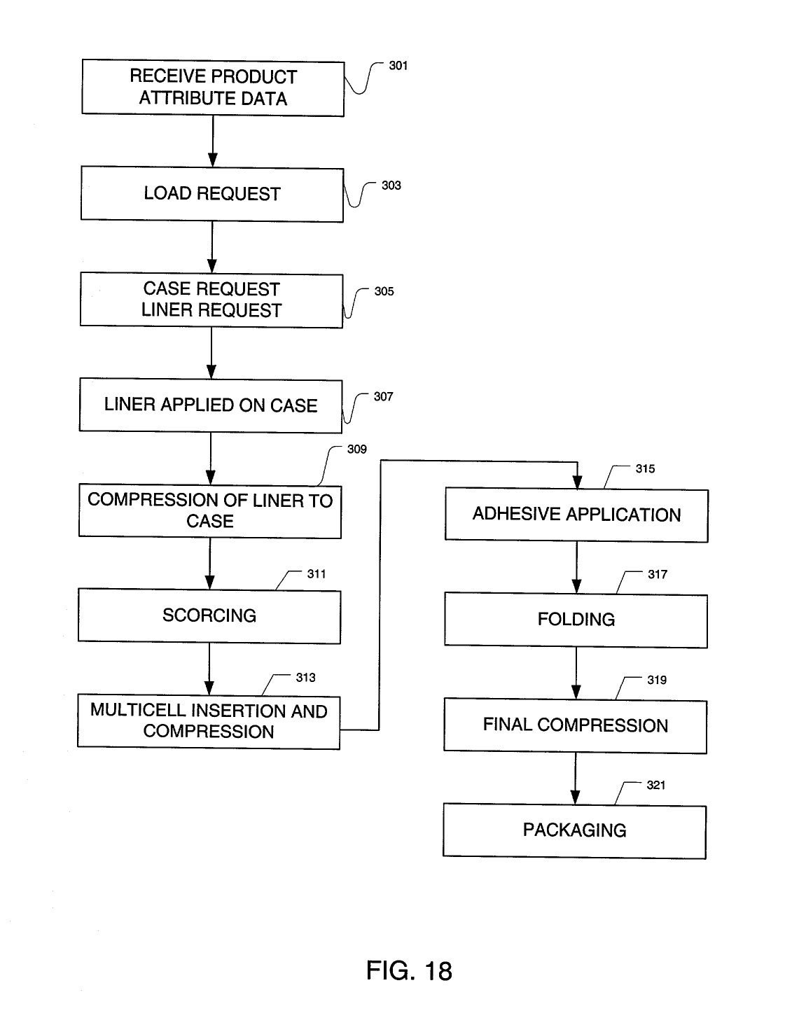

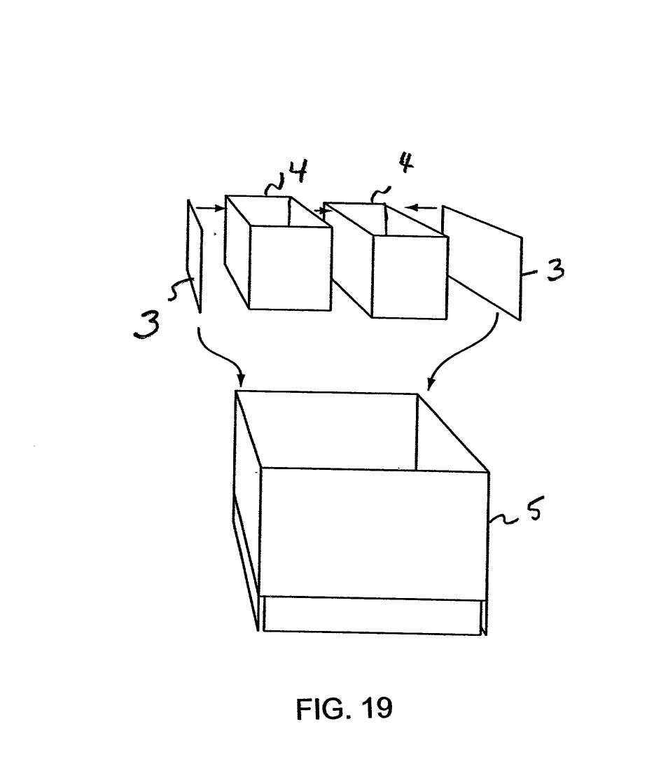

FIG. 18 illustrates a flow diagram of an operational sequence for a method of producing a multi-cell bulk box or bulk-box as carried out by forming system 1. At step 301, microprocessor controller unit 200 receives product attribute data, such a bulk box attribute data 217 or multi-cell bulk box attribute data 215. The operator can input this information by way of a touch sensitive screen (not shown) or other input means that serves as a user interface to the controller unit.

At step 303, a load request is generated such that the case and liner stacks travel from the floor belt conveyors and positioned by the case feed and the liner feed of conveyance apparatus 2. At step 305, a case request (CR) and a liner request (LR) are generated such that a single case and a single liner are picked up by vacuum cups 55 of rack units 29 located on the case feed side and liner feed side of the assembly section 7. The case request or liner request can be generated in various approaches. In one approach, the operator depresses a foot switch linked to controller unit 200. Nevertheless, the vacuum cups will drop downward until they find the case or liner. With the suction pressure actuated, the cups will make a seal on the case or liner thereby lifting them up off the appropriate stack. Once a case is lifted, the rack units will then transport the case to glue station 9 located on the case feed side.

At step 307, rollers 38 of rack unit 29 provides accurate alignment of the case so that glue station 9 reliably engages the leading edge of the case with pinch rollers 111. Once the case leading edge is in the pinch rollers 111, the vacuum cups 55 releases so that the pinch rollers pushes the case underneath the extruded glue heads to apply adhesive at predetermined locations as programmatically associated with the product attribute data. In an alternative construction, a liner may have glue applied thereon by a glue station located on the liner side. After the case has been glued, it will be positioned on locating pins for registration with the liner. After this operation has been completed, the liner will be in a ready state and released to the operator by the vacuum cups. The operator will then manually place liner in the designated location with the locating pins. In an alternative embodiment, the liner can be placed into the location by automatic systems, such as a robotic control, or by rack units 29 extending into the assembly station 7. When liner is in place, controller unit 200 will then cycle the case and coupled liner into compression section 11 for the laminating process. At this point, an optical detector (not shown), such as a photoelectric type, detects when the case board leaves assembly section 7 so to generate in a new case request.

At step 309, the compression section will compress the liner against the case with the compression platen preferably actuated by sensing the trailing edge of the case. At step 311, if there is no case in the scoring section, the case will travel into the scoring section. Depending on the mode of operation, a bulk box case will have score lines placed thereon. A case of a multi-cell bulk box is generally prescored before entering system 1 and will have adhesive applied to the liner by a subsequent gluing station, after passing through the scoring section.

In a preferred method, the following operational sequence is used, if a multi-cell box is being formed: at step 313, a laminated case and liner will stop and receive a first cell insert. This action can be manually performed or by automatic methods. Glue will be applied to the top surface of the first cell insert by a glue station controlled by controller unit 200. If desired, a second cell insert can be applied upon the first cell insert. The case, liner, and cell inserts will then be conveyed into the multi-cell compression section for lamination of the cell inserts against the liner.

Regardless of forming a multi-cell bulk box or a bulk box, the case travels to the folding unit. At step 315, if the folding unit is clear the case will travel under another set of glue heads of glue station 9 upstream of the folding unit 19 (see FIG. 1). For a bulk box, glue is applied to the glue tab. In the preferred method, for a multi-cell box, the glue station will supply adhesive to the glue tab and adhesive to the exposed multi-cell unit. At steps 317 and 319, case will then be folded and passed into the compression section 21 shown in FIG. 1. At step 321, the newly formed bulk box or multi-cell bulk box will be transported for packaging to the stacker unit 23.

Thus, a system and method of forming a multi-cell bulk box and bulk box has been described. System 1 has a modular configuration in which the components can be configured to adapt to different plant layouts. All U.S. patents referred to in this application are fully incorporated by reference for all purposes. While the present invention has been described with reference to exemplary embodiments, it will be understood by those of ordinary skill in the art that various changes may be made and equivalents may be substituted for elements thereof without departing from the scope of the invention. In addition, many modifications may be made to adapt a particular situation or material to the teachings of the invention without departing from the scope thereof. Therefore, it is intended that the invention not be limited to the particular embodiments disclosed, but that the invention will include all embodiments falling within the scope of the appended claims.

What is claimed is:

1. A method of forming a bulk box comprising the steps of:
inserting a liner against a case with an adhesive therebetween to form a composite blank;
conveying the composite blank to a compression platen;
sensing a trailing edge of the composite blank and response thereto, advancing the compression platen towards the composite blank so that the liner is bonded against the case for a predetermined duration; and
folding the bonded liner and case so as to join opposing foldable panels of the bonded liner and case towards each other to bring into an overlapping relationship at a joining portion on one of the foldable panels.

2. The method in accordance with claim 1, in which the step of sensing further includes sensing when the trailing edge passes through a light beam.

3. The method in accordance with claim 1, in which the step of folding the bonded liner and case further comprises determining whether at least one of the foldable panels has been placed in a folded position.

4. The method in accordance with claim 3, in which the step of determining further comprises sensing the absence of the least one foldable panel.

5. The method in accordance with claim 1, further comprising indexing the composite case to a multi-cell insertion station in which a multi-cell unit is inserted against the liner, in which the step of indexing occurs prior to the step of folding the bonded liner and case.

6. The method in accordance with claim 5, further comprising detecting the trailing edge of the composite blank, and responsive to the detection of the trailing edge, bonding the multi-cell unit to the liner for a predetermined period of time under a compressive pressure.

7. The method in accordance with claim 6, further comprising detecting a leading edge of the composite blank and applying extruded adhesive to the multi-cell.

8. The method in accordance with claim 1, in which the step of folding the bonded liner and case further comprises contacting a leading edge of the bonded liner and case into a plurality of movable backstops which prevents travel of the bonded liner and case so as to position the leading edge in a generally perpendicular position relative to a work path axis.

9. The method in accordance with claim 1, in which the step of folding the bonded liner and case further comprises actuating a plurality of independent negative pressure regions which hold a bottom surface of the case against a work platform.

10. A method of constructing a multi-cell bulk box, comprising the steps of:
bonding a liner to a case to form a composite case;
inserting a cell unit against the composite case with adhesive therebetween;
detecting a trailing edge of the composite case, while the composite case travels underneath a compression platen;
responsive to the detection of the trailing edge, advancing the compression platen towards the cell unit so that the cell unit is bonded to the composite case for a predetermined period of time; and
folding at least two panels of the composite case in an overlapping position at a glue tab on one of the panels.

11. The method in accordance with claim 10, further comprising detecting a leading edge of the composite case and applying adhesive to the glue tab and the cell unit, prior to the step of folding the at least two panels.

12. The method in accordance with claim 10, wherein the step of folding the at least two panels, includes sensing whether of the panels of the composite case are in a folded position, and in response to the sensing, executing a step of compressing the glue tab and the cell unit to the composite case.

13. The method in accordance with claim 10, in which the step of folding further comprises contacting a leading edge of the composite case into a plurality of movable backstops which prevents travel the composite case so as to position a leading edge of the composite case in a generally perpendicular position relative to a work path.

14. The method in accordance with claim 13, further comprising responsive to sensing the leading edge of the composite case, actuating a plurality of negative pressure regions for holding the composite case stationary during folding of the at least two panels.

15. A multi-cell bulk box lamination system, comprising:
a multi-cell insertion station for applying a multi-cell unit against a liner adhesively attached to a case having at least two foldable panels;
a multi-cell compression apparatus receiving the multi-cell unit, liner and case, in which a detector monitors a work path and generates a detection signal upon sensing a trailing edge of the case, while the case is conveyed in the work path underneath a compression platen that compresses the multi-cell unit against the liner;
a folding apparatus having a plurality of rotatable arms for folding the foldable panels towards the multi-cell unit; and
a control processor having a program embodied in computer readable code for monitoring and receiving the detection signal from the detector so as to control movement of the compression platen.

16. The system in accordance with claim 15, further comprising a conveying apparatus for lifting and transporting at least one of the case and the liner, responsive to control signals from the control processor.

17. The system in accordance with claim 16, further comprising a gluing apparatus that receives a leading edge of the case from the conveying apparatus and applies adhesive to an inside surface of the foldable panels.

18. The system in accordance with claim 17, further comprising an assembly platform having a plurality of endless belts which are initially positioned underneath in a spaced relationship to the case, then move upward to engage an underside of the case upon command of the control processor.

19. The system in accordance with claim 15, further comprising a liner compression apparatus having a lamination platen in which the liner and case are received prior to the multi-cell insertion station, the liner compression apparatus having a trailing edge detector that senses the trailing edge of the case so that the liner is compressed against the case.

20. The system in accordance with claim 15, in which the folding apparatus further includes at least one case sensor that generates a detection signal so as to verify that at least one of the folding arms has folded one of the foldable panels.

21. The system in accordance with claim 20, wherein the folding apparatus further includes a linearly actuated member that prevents travel of the case by abutting a leading edge of the case upon command of the control processor for straightening the case within the folding apparatus.

22. The system in accordance with claim 15, wherein the multi-cell compression apparatus further includes a receiving end having a leading edge sensor transmitting arrival data to the control processor.

23. The system in accordance with claim 15, further comprising an operative connection to a telecommunications network for transmitting production data across the telecommunications network, including the World Wide Web.

24. A bulk box lamination system, comprising:
an assembly platform for placing a liner against a case having adhesive therebetween thereby forming a composite case;
a compression apparatus having an edge detector which generates a detection signal upon sensing a trailing edge of the composite case and the compression apparatus further having a transport surface that transports the composite case to a compression platen which applies a compression pressure to the liner and the case responsive to the sensing of the trailing edge;
a folding apparatus having a plurality of rotary folding arms which fold opposing foldable panels of the composite case towards each other to bring into an overlapping position at a glue tab disposed on one of the foldable panels; and
a control computer having a computer readable program for execution on a processing unit responsive to at least receiving the detection signal from the edge detector.

25. The system in accordance with claim 24, further comprising a gluing apparatus configured to sense a leading edge of the composite case so as to apply adhesive to an exposed surface of the liner for receiving a multi-cell unit.

26. The system in accordance with claim 25, further comprising an insertion station for applying the multi-cell unit against the exposed surface of the liner.

27. The system in accordance with claim 26, further comprising a multi-cell compression apparatus that bonds the multi-cell unit to the exposed surface of the liner under a compressive pressure.

28. The system in accordance with claim 25, in which the gluing apparatus further includes a plurality of extruded glue heads mounted to a moveable rod.

29. The system in accordance with claim 28, in which the gluing apparatus further includes a plurality of air bag actuators which moves the moveable rod downward so that the extruded glue heads contact the exposed surface of the liner.

30. The system in accordance with claim 24, in which the folding apparatus further comprises at least one case detector that generates a detection signal so as to determine that at least one of the panels of the case has been folded.

31. The system in accordance with claim 24, in which the edge detector is photoelectric.

32. A method of forming a bulk box comprising the steps of:
inserting a liner against a case with an adhesive therebetween to form a composite blank having a leading edge and a trailing edge;
conveying the composite blank to a compression platen;
sensing the leading edge of the composite blank and response thereto, initiating an encoder which determines a position of the trailing edge underneath the compression platen to advance the compression platen towards the composite blank so that the liner is bonded against the case for a predetermined duration; and
folding the bonded liner and case so as to join opposing foldable panels of the bonded liner and case towards each other to bring into an overlapping relationship at a joining portion on one of the foldable panels.

33. The method in accordance with claim 32, in which the step of sensing further includes sensing when the leading edge passes through a light beam.

34. The method in accordance with claim 32, in which the step of folding the bonded liner and case further comprises determining whether at least one of the foldable panels has been placed in a folded position.

35. The method in accordance with claim 34, in which the step of determining further comprises sensing the absence of the least one foldable panel.

36. The method in accordance with claim 32, further comprising indexing the composite blank to a multi-cell insertion station in which a multi-cell unit is inserted against the liner, in which the step of indexing occurs prior to the step of folding the bonded liner and case.

37. The method in accordance with claim 32, in which the step of folding the bonded liner and case further comprises contacting a leading edge of the bonded liner and case into at least one movable backstops which prevents travel of the bonded liner and case so as to position the leading edge in a generally perpendicular position relative to a work path axis.

38. The method in accordance with claim 37, in which the step of folding the bonded liner and case further comprises actuating a plurality of independent negative pressure regions which hold a bottom surface of the case against a work platform upon sensing the leading edge of the bonded liner and case.

39. A bulk box lamination system, comprising:
an assembly platform for placing a liner against a case having adhesive therebetween thereby forming a composite blank;
a compression apparatus having an edge detector which generates a detection signal upon sensing a leading edge of the composite blank and an encoder, the compression apparatus further having a transport surface that transports the composite blank to a compression platen which applies a compression pressure to the liner and the case responsive to a plurality of predetermined counts from the encoder;
a folding apparatus having a plurality of rotary folding arms which fold opposing foldable panels of the composite blank towards each other to bring into an overlapping position at a joining portion disposed on one of the foldable panels; and
a control computer having a computer readable program for execution on a processing unit responsive to at least receiving the detection signal from the edge detector and the predetermined counts from the encoder.

40. The system in accordance with claim 39, further comprising a gluing apparatus configured to sense the leading edge of the composite blank so as to apply adhesive to an exposed surface of the liner for receiving a multi-cell unit.

41. The system in accordance with claim 40, further comprising an insertion station for applying the multi-cell unit against the exposed surface of the liner.

42. The system in accordance with claim 40, further comprising a multi-cell compression apparatus that bonds the multi-cell unit to the exposed surface of the liner under a compressive pressure.

43. The system in accordance with claim 40, in which the gluing apparatus further includes a plurality of extruded glue heads mounted to a moveable rod.

44. The system in accordance with claim 43, in which the gluing apparatus further includes a plurality of air bag actuators which moves the moveable rod downward so that the extruded glue heads contact the exposed surface of the liner.

45. The system in accordance with claim 39, in which the folding apparatus further comprises at least one case detector that generates a detection signal so as to determine that at least one of the foldable panels of the case has been folded.

46. The system in accordance with claim 39, in which the edge detector is photoelectric.

47. An apparatus for folding a bulk box, comprising:
a plurality of opposing folding arms which rotate toward each other for folding at least two predetermined panels of bulk box case;
at least one sensor which senses the bulk box case so as to determine that at least one of the predetermined panels of the bulk box case has been folded;
a plurality of lateral spaced platforms for retaining a predetermined portion of the bulk box case thereagainst for a duration of folding the two predetermined panels of the bulk box case; and
a control processor for controlling the folding arms and the at least one sensor.

48. The apparatus in accordance with claim 47, in which each platform includes a plurality of selective negative pressure regions, which retain the predetermined portion of the bulk box case.

49. The apparatus in accordance with claim 48, further including a position sensor for sensing when the bulk box case is in a predetermined position so as to actuate the negative pressure regions with the control processor.

50. The apparatus in accordance with claim 49, further including a plurality of movable members that stop movement of the bulk box case while the bulk box case is conveyed to discharge ends of the platforms so as to abut a leading edge of the bulk box case upon command of the control processor for straightening the bulk box case.
